(19) United States
(12) Patent Application Publication
(10) Pub. No.: US 2015/0229618 A1
(43) Pub. Date: Aug. 13, 2015

(54) System and Method for Securing Source Routing Using Public Key based Digital Signature

(71) Applicant: FUTUREWEI TECHNOLOGIES, INC., Plano, TX (US)

(72) Inventors: Tao Wan, Ottawa (CA); Peter Ashwood-Smith, Gatineau (CA); Mehdi Arashmid Akhavain Mohammadi, Ottawa (CA); Guoli Yin, Ottawa (CA); Yapeng Wu, Nepean (CA)

(73) Assignee: FUTUREWEI TECHNOLOGIES, INC., Plano, TX (US)

(21) Appl. No.: 14/177,913

(22) Filed: Feb. 11, 2014

(51) Int. Cl. H04L 29/06; H04L 12/721

(52) U.S. Cl. CPC H04L 63/06; H04L 45/44

(57) ABSTRACT

Embodiments are provided for securing source routing using public key based digital signature. If a protected source route is tampered with, a public key based method allows a downstream node to detect the tampering. The method is based on using digital signatures to protect the integrity of source routes. When creating a source route for a traffic flow, a designated network component computes a digital signature and adds the digital signature to the packets. When the packets are received at a node on the route, the node uses the digital signature and a public key to verify the source route and determines accordingly whether the source route has been tampered with. If tampering is detected, the receiving node stops the forwarding of the packets.

### TECHNICAL FIELD

The present invention relates to the field of network communications and routing, and, in particular embodiments, to a system and method for securing source routing using public key based digital signature.

### BACKGROUND

Using source routing in networks, packets are routed from a receiving node to a next node according to a source route indicated in the packet. Typically, routing protocols such as MPLS segment routing, employ source routing mechanisms without security protection regarding maintaining integrity of source routes in the packets. As such, the source routes are usually indicated in packets in plaintext without any protection. Thus, the source routes in the packets can be subject to tampering, such as modification, deletion, or insertion, for example by a node on the routing path. The tampering can cause rerouting of such packets to unintended destinations. This tampering is in violation of network operators' security policies that dictate the source routes, and harms network and user security. There is a need for an efficient security mechanism to protect the integrity of source routes.

### SUMMARY OF THE INVENTION

In accordance with an embodiment of the disclosure, a method by a network component for securing source routing using public key based digital signature includes generating, using a private key of the network component, a digital signature for a source route determined for routing traffic in a network. The source route indicates a sequence of nodes in the network. The method further includes providing a secure source route as a combination of the digital signature and the source route. The secure source route is added to packets of the traffic, and the packets are sent on the source route.

In accordance with another embodiment of the disclosure, a network component for securing source routing using a public key includes at least one processor and a non-transitory computer readable storage medium storing programming for execution by the processor. The programming includes instructions to generate, using a public key, a digital signature for a source route determined for routing traffic in a network. The source route indicates a sequence of nodes in the network. The programming includes further instructions to provide a secure source route as a combination of the digital signature and the source route. The programming further configures the network component to add the secure source route to packets of the traffic, and send the packets on the source route.

In accordance with another embodiment of the disclosure, a method by a network node for securing source routing using a public key includes receiving a packet including a source route and a digital signature generated according to the source route and a private key unknown to the network node. The source route indicates a sequence of nodes in the network. The method further includes validating the source route using the digital signature and a public key known to the network node. Upon determining a mismatch of the source route, a notification message is sent to the network indicating a tampering of the source route.

In accordance with yet another embodiment of the disclosure, a network node for early termination in iterative single value decomposition includes at least one processor and a non-transitory computer readable storage medium storing programming for execution by the processor. The programming includes instructions to receive a packet including a source route and a digital signature generated according to the source route and a private key unknown to the network node. The source route indicates a sequence of nodes in the network. The programming includes further instructions to validate the source route using the digital signature and a public key known to the network node. The network node is further configured to, upon determining a mismatch of the source route, send a notification message to the network indicating a tampering of the source route.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an exemplary scenario of tampering with source routes to reroute packets;

FIG. 2 illustrates an embodiment of a protected source route;

FIG. 3 illustrates an embodiment of a method for protecting source routes; and

FIG. 4 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments are provided herein for securing source routing using public key based digital signature. If a protected source route is tampered with, a public key based method allows a downstream node to detect the tampering. The method is based on using digital signatures to protect the integrity of source routes. When creating a source route for a traffic flow, a designated network node such as a software-defined networking (SDN) controller computes a digital signature and adds the digital signature to the packets. When the packets are received at a node on the route, the node uses the digital signature and a public key to verify the source route and determines accordingly whether the source route has been tampered with. If tampering is detected, the node stops the forwarding of the packets.

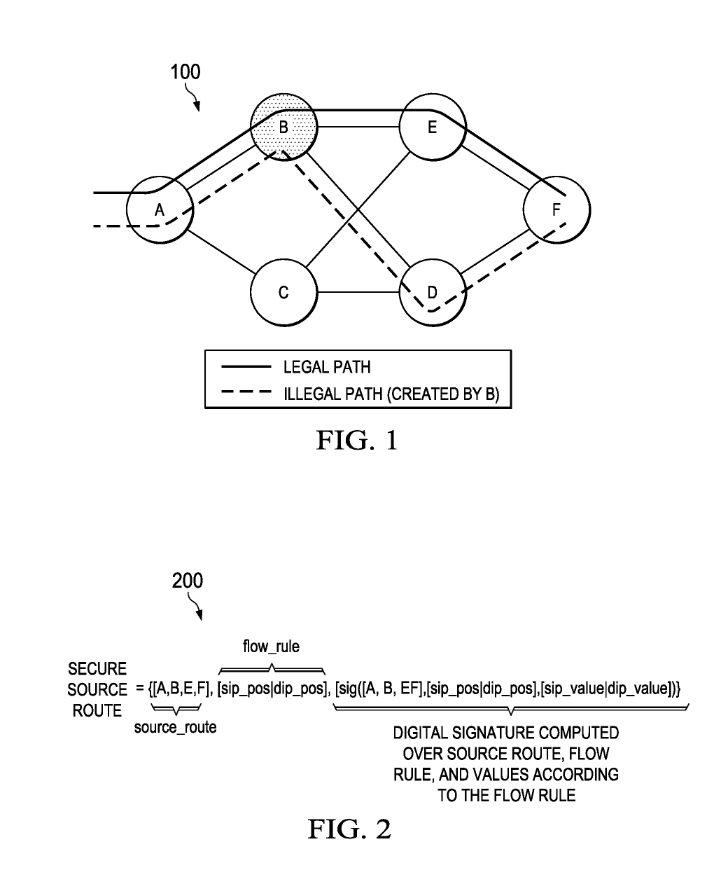

FIG. 1 shows an exemplary scenario 100 of tampering with a source route to reroute packets. In the scenario 100, A SDN controller (not shown) determines a source route along nodes [A,B,E,F], in that order, for a given traffic flow to meet security policy of a network. The network comprises a plurality of nodes including A, B, C, D, E, and F. The nodes may be routers, switches, gateways, bridges, of other network nodes that forward packets in the network. The security policy can be enforced if all nodes behave properly and forward traffic according to the source route. However, a misbehaving node B can change the source route in the packet, upon receiving the traffic, to an illegal path, [A,B,D,F], without being detected by any downstream node (E, D, or F). In this case, B can bypass the security policy by not forwarding traffic to E, which may host certain security services (e.g., virtual firewalls) for the traffic.

To avoid this situation, the SDN controller is configured to generate a digital signature for the source route, e.g., upon determining the source node. FIG. 2 shows an embodiment of a protected source route 200. The protected or secure source route 200 includes a digital signature generated by the SDN controller according to a private key only know by the SDN controller and not shared with network nodes. The secure source route 200 further includes the actual source route and possibly flow rules. The flow rules can be in several forms, including but not limited to flow identifiers pointing to the flow rules preconfigured on each node, positions and corresponding lengths of the fields in a packet to be used for identifying flows, or other forms. The flow rules are used to identify additional values (e.g., destination address) in the packet to be used for generating the digital signature. For example, the source route is the legal source route of scenario 100, [A,B,E,F], and the flow rules identify the source Internet Protocol (IP) address (sip) and/or destination IP address (dip). The digital signature can be a function of the source route and the identified addresses according to the flow rules, e.g., sig([A,B,E,F],[sip|dip]). The source route, the flow rules, and the digital signature that form the secure source route 200 can be included in the packet header.

When receiving a packet with the secure source route 200, a node verifies the source route against the digital signature using a public key shared by the nodes and the SDN controller. For instance, the public key can be found in the SDN controller's public key certificate, which is usually preconfigured on each node. Alternatively, the public key can be broadcast or multicast to the nodes by the SDN controller or the network. The receiving node can validate the source route using a function of the public key and the digital signature in the packet. If the function results in a mismatch, an error and/or a notification message is sent by the node to the SDN controller for taking further action. The node signals the SDN controller that the source route was tampered with, e.g., by a preceding node on the route. For example, in scenario 100, node F uses the public key based function to detect a tampering of the source route in the received packet.

Since only the SDN controller has the knowledge of the private key, no other node could create a valid digital signature for a falsified source route. This provides integrity protection for the source route. Further, to reduce overhead from transmitting a digital signature, a hash of the digital signature, or a portion of the hash, instead of the digital signature itself can be included in the packet. Upon validation, a node first computes the digital signature as described above, then computes the hash of the digital signature, and subsequently validates the computed hash against the one included in the packet. To further reduce overhead from both transmitting and validating digital signatures, secure source routes can be cached at the nodes once they have been validated, and future packets only need to include regular source routes, e.g., the actual source route only portion in the protected source route 200. The receiving node can compare the source route in the subsequent packets with the cached secure source route or with the cached digital signature using the public key.

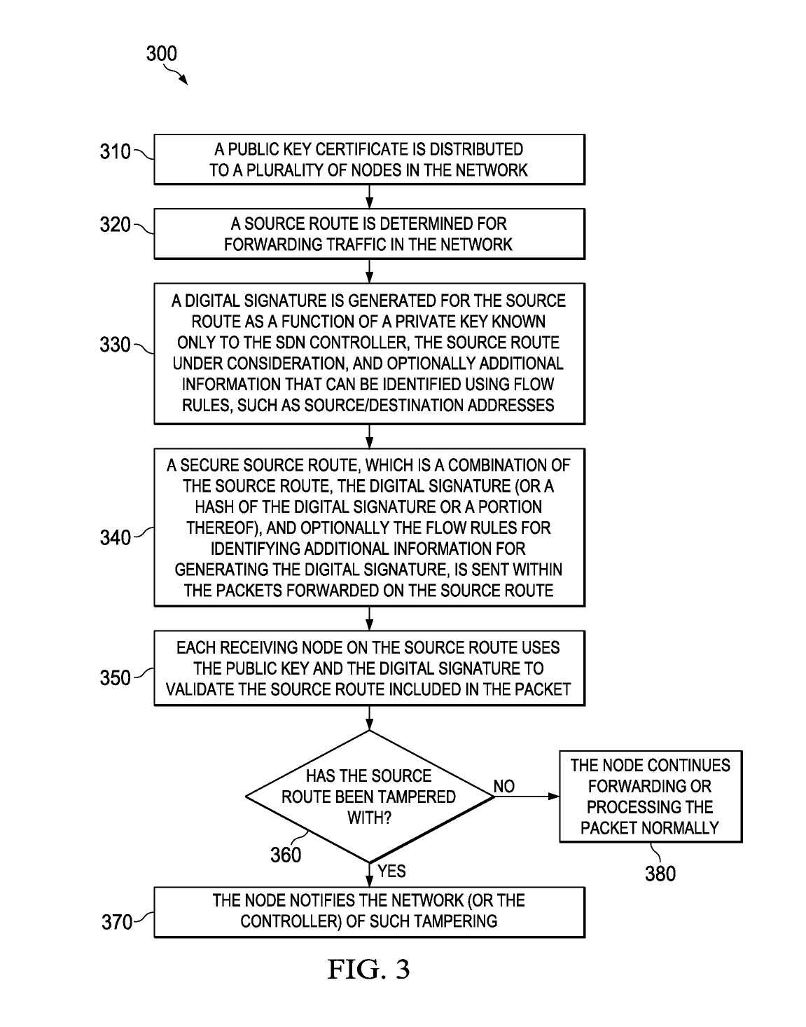

FIG. 3 shows an embodiment of a method 300 for protecting source routes. At step 310, a public key certificate is distributed to a plurality of nodes in the network, for example by a SDN controller or any responsible network entity. At step 320, a source route is determined for forwarding traffic in the network. At step 330, the SDN controller or responsible entity generates a digital signature for the source route as a function of a private key known only to the controller or entity, the source route under consideration, and optionally additional information that can be identified using flow rules, such as source/destination addresses. At step 340, a secure source route, which can be a combination of the source route, the digital signature (or a hash or a portion of the hash of the digital signature), and optionally the flow rules for identifying additional information for generating the digital signature, is sent within the packets forwarded on the source route. At step 350, each receiving node on the source route uses the public key and the digital signature to validate the source route included in the packet. At step 360, the receiving node determines whether the source route has been tampered with, e.g., if there is a mismatch between the source route in the packet and the result of processing the digital signature by the public key. If the source route has been tampered with, then the node notifies the network (or the controller) of such tampering at step 370. The packet may be discarded and the forwarding is stopped. Otherwise, the node continues forwarding or processing the packet normally at step 380. In the method 200, the steps 310 to 340 are implemented by the controller or network entity. The steps 350 to 380 are implemented by each receiving node or the destination node.

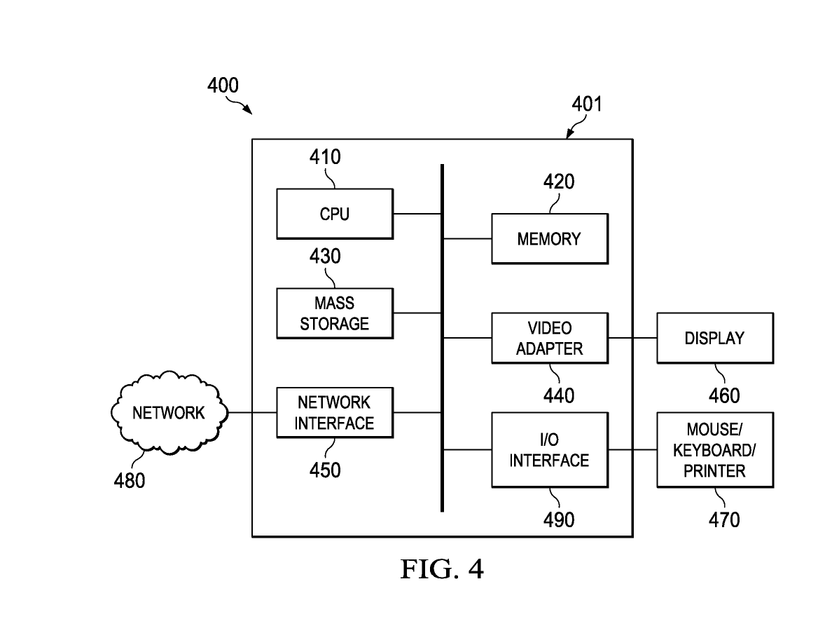

FIG. 4 is a block diagram of an exemplary processing system 400 that can be used to implement various embodiments. The processing system can be part of a controller (or network entity) or a node that receives and/or transmits packets according to source routing. In an embodiment, the processing system 400 can be part of a cloud or distributed computing environment, where the different components can be located at separate or remote components from each other and connected via one or more networks. The processing system 400 may comprise a processing unit 401 equipped with one or more input/output devices, such as a speaker, microphone, mouse, touchscreen, keypad, keyboard, printer, display, and the like. The processing unit 401 may include a central processing unit (CPU) 410, a memory 420, a mass storage device 430, a video adapter 440, and an Input/Output (I/O) interface 490 connected to a bus. The bus may be one or more of any type of several bus architectures including a memory bus or memory controller, a peripheral bus, a video bus, or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The video adapter 440 and the I/O interface 490 provide interfaces to couple external input and output devices to the processing unit. As illustrated, examples of input and output devices include a display 460 coupled to the video adapter 440 and any combination of mouse/keyboard/printer 470 coupled to the I/O interface 490. Other devices may be coupled to the processing unit 401, and additional or fewer interface cards may be utilized. For example, a serial interface card (not shown) may be used to provide a serial interface for a printer.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a network component for securing source routing using public key based digital signature, the method comprising:
generating, using a private key of the network component, a digital signature for a source route determined for routing traffic in a network, wherein the source route indicates a sequence of nodes in the network;
providing a secure source route as a combination of the digital signature and the source route;
adding the secure source route to packets of the traffic; and
sending the packets on the source route.

2. The method of claim 1 further comprising distributing, to the nodes, a public key for validating the source route.

3. The method of claim 1, wherein distributing the public key comprises preconfiguring a certificate of the public key at the nodes.

4. The method of claim 1, wherein providing the secure source route includes further adding flow rules with the digital signature and the source route in the packets.

5. The method of claim 4, wherein the digital signature is a function of the source route and flow information identified by the flow rules, and wherein the flow information includes at least one of a source address and a destination address.

6. The method of claim 1, wherein the private key of the network component is not shared with the nodes.

7. A network component for securing source routing using a public key, the network component comprising:
at least one processor; and
a non-transitory computer readable storage medium storing programming for execution by the processor, the programming including instructions to:
generate, using a public key, a digital signature for a source route determined for routing traffic in a network, wherein the source route indicates a sequence of nodes in the network;
provide a secure source route as a combination of the digital signature and the source route;
add the secure source route to packets of the traffic; and
send the packets on the source route.

8. The network component of claim 7, wherein the programming further includes instructions to distribute, to the nodes, a public key for validating the source route.

9. The network component of claim 7, wherein the instructions to provide the secure source route include further instructions to include flow rules with the digital signature and the source route in the packets, and wherein the digital signature is a function of the source route and flow information identified by the flow rules.

10. The network component of claim 7, wherein the network component is a software-defined networking (SDN) controller.

11. A method by a network node for securing source routing using a public key, the method comprising:
receiving a packet including a source route and a digital signature, wherein the digital signature is generated according to the source route and a private key unknown to the network node, and wherein the source route indicates a sequence of nodes in the network;
validating the source route using the digital signature and a public key known to the network node; and
upon determining a mismatch of the source route, sending a notification message to the network, the notification message indicating a tampering of the source route.

12. The method of claim 11, wherein the packet further includes flow rules comprising flow information, the flow information identifying at least one of a source address and a destination address, and wherein the digital signature is a function of the source route and the flow information.

13. The method of claim 11, wherein validating the source route using the digital signature and the public key includes:
obtaining a local source route as a function of the digital signature and the public key; and
comparing the local source route with the source route in the packet.

14. The method of claim 11 further comprising receiving a certificate of the public key from the network.

15. The method of claim 11 further comprising:
caching the source route or the digital signature at the network node; and
validating a second source route in a second received packet subsequent to the packet using the cached source route or using the cached digital signature and the public key.

16. The method of claim 15, wherein the second packet does not include the digital signature.

17. A network node for early termination in iterative single value decomposition, the network node comprising:
at least one processor; and
a non-transitory computer readable storage medium storing programming for execution by the processor, the programming including instructions to:
receive a packet including a source route and a digital signature, wherein the digital signature is generated according to the source route and a private key unknown to the network node, and wherein the source route indicates a sequence of nodes in the network;
validate the source route using the digital signature and a public key known to the network node; and
upon determining a mismatch of the source route, send a notification message to the network, the notification message indicating a tampering of the source route.

18. The network node of claim 17, wherein the packet further includes flow rules comprising flow information, the flow information identifying at least one of a source address and a destination address, and wherein the digital signature is a function of the source route and the flow information.

19. The network node of claim 17, wherein the instructions to validate the source route using the digital signature and the public key include further instructions to:
obtain a local source route as a function of the digital signature and the public key; and
compare the local source route with the source route in the packet.

20. The network node of claim 17, wherein the programming includes further instructions to:
cache the source route or the digital signature at the network node; and
validate a second source route in a second received packet subsequent to the packet using the cached source route or using the cached digital signature and the public key.
